(19) United States
(12) Patent Application Publication
(10) Pub. No.: US 2024/0301333 A1
(43) Pub. Date: Sep. 12, 2024

(54) BREWING PLANT WITH HOT WATER STORAGE DEVICE

(71) Applicant: BANKE GMBH, Taufkirchen (DE)

(72) Inventor: Stefan Pfister, Eggolsheim (DE)

(21) Appl. No.: 18/595,859

(22) Filed: Mar. 5, 2024

(30) Foreign Application Priority Data
Mar. 6, 2023 (DE) DE102023105429.5

(51) Int. Cl. C12C 7/22; C12C 7/26

(52) U.S. Cl. CPC C12C 7/22; C12C 7/26

(57) ABSTRACT

A brewing plant, comprising: a hot water storage device, including a high temperature portion and a low temperature portion, at least one high temperature water inlet, at least one high temperature water outlet, at least one low temperature water inlet, at least one low temperature water outlet; a mash container; a lauter tun or a mash filter flow connected with the mash container by a mash conduit; a wort kettle including a lauter wort inlet, a wort outlet, and an exhaust vapor condenser including a low temperature water connection and a high temperature water connection, wherein the lauter wort inlet is directly or indirectly connected through a lauter wort conduit with the lauter tun or the mash filter, wherein the low temperature water outlet of the hot water storage device is connected with the low temperature water connection of the exhaust vapor condenser.

### RELATED APPLICATIONS

This application claims priority from and incorporates by reference German patent application DE 10 2023 105 419.5 filed on Mar. 6, 2023

### FIELD OF THE INVENTION

The invention relates to brewing plants including a hot water storage device including a high temperature portion and a low temperature portion. This hot water storage device is configured as an arrangement of two or more hot water storage containers, which respectively cover a different temperature range.

### BACKGROUND OF THE INVENTION

Energy management of brewing plants is more and more important in view of rising energy cost. A major portion of the energy required for a brewing process in a brewing plant is thermal energy. Recapture of thermal energy from waste heat from the brewing process, e.g. when cooling down wort, and reusing this energy for heating the process liquid, e.g. lauter wort before introduction into the wort kettle, is known in the art and has been used for a long time. Therefore, it is important to minimize heat losses in multiple heat exchange processes and thus improve thermal energy efficiency of the brewing plants. Typically heat exchange loops are used for this purpose wherein the heat exchange loops are separate from the flow of brewing process fluid, e.g. the wort or the beer.

EP 2 516 614 B1 discloses a device and a method for recapturing energy in a beer brewery wherein a heat exchange loop is provided that is separate from the process fluid flow. The heat exchange loop includes a heat transport fluid, e.g. water, and forms a closed conduit system including heat exchangers for transferring heat between the process fluid and the heat transfer fluid and a storage container for the heat transfer fluid that forms the energy storage device and that is configured as a stratified storage tank.

Thermal energy recovered from wort boiling and wort cooling is stored in the energy storage device. Thermal energy in a hotter head space of the stratified storage tank recaptured during wort boiling e.g. by a kettle vapor condenser is reused for heating the lauter wort. Thermal energy recovered from the wort cooling process through a wort cooler can be used to indirectly heat the mash.

Hot water from the energy storage device is thus introduced into a heating heat exchanger of a mash tank so that the mash in the mash tank is heated. It is a disadvantage that the heating surfaces of the heating heat exchanger have to be configured very large due to the comparatively low temperature of the heating medium in order to be able to transfer the required thermal energy from the heat transfer fluid that runs in a closed heat exchange system so that the thermal energy is transferred into the mash. This requires a rather large surface area for the heating heat exchanger in or at the mash kettle. Heating surfaces are limited in size in particular when upgrading and retrofitting existing plants so that the mash tanks typically have to be replaced which is expensive.

### BRIEF SUMMARY OF THE INVENTION

Thus, it is an object of the invention to provide an improved brewing plant that requires little installation space and that improves thermal efficiency or that can be upgraded to improve thermal efficiency using existing plant components without having to replace kettles or containers on a large scale.

This object is achieved according to the invention by a first embodiment of a brewing plant, comprising a hot water storage device, including a high temperature portion and a low temperature portion, at least one high temperature water inlet, at least one high temperature water outlet, at least one low temperature water inlet, at least one low temperature water outlet; a mash container; a lauter tun or a mash filter flow connected with the mash container by a mash conduit; a wort kettle including a lauter wort inlet, a wort outlet, and an exhaust vapor condenser including a low temperature water connection and a high temperature water connection, wherein the lauter wort inlet is directly or indirectly connected through a lauter wort conduit with the lauter tun or the mash filter, wherein the low temperature water outlet of the hot water storage device is connected with the low temperature water connection of the exhaust vapor condenser and the high temperature water inlet of the hot water storage device is flow connected with the high temperature water connection of the exhaust vapor condenser, characterized in that the hot water storage device includes at least one first hot water storage container which includes or forms the high temperature portion and at least one second hot water storage container that includes or forms the low temperature portion, and that the hot water storage device configured as an arrangement of two or more hot water storage containers is flow connected through a fresh water conduit with a fresh water storage and that the high temperature water outlet of the hot water storage device is flow connected through a mash water conduit with a hot water inlet of the mash kettle.

According to a second embodiment of the invention the object is achieved by a brewing, comprising a hot water storage device, including a high temperature portion and a low temperature portion, at least one high temperature water inlet, at least one high temperature water outlet, at least one low temperature water inlet, at least one low temperature water outlet; a mash container; a lauter tun or a mash filter flow connected with the mash container by a mash conduit; a wort kettle including a lauter wort inlet, a wort outlet, and an exhaust vapor condenser including a low temperature water connection and a high temperature water connection, wherein the lauter wort inlet is directly or indirectly connected through a lauter wort conduit with the lauter tun or the mash filter, wherein the wort outlet is directly or indirectly flow connected with the wort cooler, wherein a cold-water inlet of the wort cooler is provided with cold water by an external feed conduit, wherein the cold water is heated in the wort cooler, wherein the wort cooler includes a hot water outlet that is flow connected through an internal feed conduit with the high temperature water inlet of the hot water storage device, characterized in that the hot water storage device includes at least one first hot water storage container which includes or forms the high temperature portion and at least one second hot water storage container that includes or forms the low temperature portion, and that the external feed conduit is flow connected with the fresh water storage and the external feed conduit and the internal feed conduit form the fresh water feed of the hot water storage device formed as two or more hot water storage containers.

According to a third embodiment of the invention the object is achieved by a brewing plant, comprising a hot water storage device, including a high temperature portion and a low temperature portion, at least one high temperature water inlet, at least one high temperature water outlet, at least one low temperature water inlet, at least one low temperature water outlet; a mash container; a lauter tun or a mash filter flow connected with the mash container by a mash conduit; a wort kettle including a lauter wort inlet, a wort outlet, and an exhaust vapor condenser including a low temperature water connection and a high temperature water connection, wherein the lauter wort inlet is directly or indirectly connected through a lauter wort conduit with the lauter tun or the mash filter, wherein the low temperature water outlet of the hot water storage device is connected with the low temperature water connection of the exhaust vapor condenser and the high temperature water inlet of the hot water storage device is flow connected with the high temperature water connection of the exhaust vapor condenser, wherein the wort outlet is directly or indirectly flow connected with a wort cooler, wherein a cold-water inlet of the wort cooler is provided with cold water by an external feed conduit, wherein the cold water is heated in the wort cooler, wherein the wort cooler includes a hot water outlet that is flow connected through an internal feed conduit with the high temperature water inlet of the hot water storage device to exhaust the hot water from the wort cooler, characterized in that the hot water storage device includes at least one first hot water storage container which includes or forms the high temperature portion and at least one second hot water storage container that includes or forms the low temperature portion, and that the hot water storage device configured as an arrangement of two or more hot water storage containers is flow connected through a fresh water conduit with a fresh water storage and that the high temperature water outlet of the hot water storage device is flow connected through a mash water conduit with a hot water inlet of the mash kettle.

### Advantages of the Invention

All three embodiment of the brewing plant according to the invention have in common that fresh water is advantageously used as a heat transfer medium in an open heat transfer system for exchanging thermal energy between the individual plant components. Water supplied from a fresh water tank or a sufficiently sized fresh water conduit, thus from the fresh water supply of the brewing plant is either heated in the exhaust vapor condenser (first embodiment) or in the wort cooler (second embodiment) or in the exhaust vapor condenser and in the wort cooler (third embodiment) and stored in an intermediary manner in the hot water storage device configured as a buffer storage for the thermal energy. From there the water is fed as a hot process fluid (brew water) into mash provided in a mash container, e.g. into a mash container where the brew water quickly mixes with the mash directly heating the mash which differs from the indirect heating through a known heat exchanger. This direct heating of the mash occurs more quickly and with less reaction since the direct mixing causes an even temperature distribution almost immediately. This process according to the invention can also be designated as feeding hot process fluid (brew water) during mashing. The target temperature in the mash is controlled by an amount of hot fresh brew water introduced from the hot water storage device into the mash container and by its temperature and by an amount of mash initially included in the mash container and by an initial temperature of the mash.

The combined energy recovery from the wort boiling and the wort cooling according to the third embodiment at a similar temperature level allows lowering the evaporation coefficient below a level that is possible in plants that have an energy storage device that is included in a separate heat recovery loop where the wort boiling and the lauter wort heating have to be at an equilibrium. The evaporation coefficient provides a percentage per hour of an evaporated amount of water with reference to a cast wort that is obtained by the wort boiling and that is defined as 100%. This equilibrium of the energy amounts of wort boiling and lauter wort heating is only reached with an evaporation coefficient of approximately 4-4.5% in known plants that have a heat recovery cycle that is separate from the brew liquid flow. From a technical point of view, however, only significantly lower evaporation figures (approximately 2-3.5%) are required. The solution according to the invention using fresh water for heat recovery from wort boiling and wort cooling facilitates lowering the evaporation coefficient using excess hot water from the brewery which facilitates energy savings over the prior art.

Particularly advantageously hot fresh brew water is introduced from the hot water storage device into the mash container in an area of a base of the mash container, thus from below into the existing mash. A turbulent flow caused in the mash due to a rise of the lighter hot brew water compared to the cooler and higher viscosity mash causes a quick mixing and thus a quick reaching of an even temperature distribution in the diluted mash. A conduit arrangement for introducing the hot brew water into an outer base portion of the mash container is particularly advantageous since the turbulence of mash stirring devices that may be included in the mash container is the highest, so that the quickest mixing is achieved. Ideally the stirring device of the mixing device is provided with reinforcements which further accelerate mixing.

Further advantageous embodiments of the brewing plant according to the invention are specified in the dependent claims.

Advantageously the temperature of water exiting from the high temperature water connection of the exhaust vapor condenser during brewing operations of the brewing plant is in a range of 95° C. to 99° C., advantageously between 96° C. to 99° C., further advantageously between 98° C. and 99° C. This high level of thermal energy recovery from exhaust vapor rising from the wort kettle efficiently minimizes the loss of thermal energy.

Particularly advantageously the temperature of water exiting from the wort cooler into the inner fed conduit during brewing operations of the brewing plant is in a range of 95° C. to 97° C., advantageously between 96° C. and 97° C. This also achieves very efficient heat recovery.

Particularly advantageously a temperature of water exiting from the wort cooler into the inner feed conduit during brewing operations of the brewing plant is lower than a temperature of hot wort entering the wort cooler by a maximum amount of 2° C., advantageously by a maximum amount of 1° C. This further improves heat recovery and further reduces a loss of thermal energy.

In another advantageous embodiment a temperature of water entering the wort cooler from the feed conduit that is flow connected with the fresh water supply is warmer than 0° C. and colder than 10° C., advantageously 6° C. or colder, further advantageously 4° C. or colder. This not only extracts a particularly large amount of thermal energy from the fresh water introduced into the wort cooler but the wort is also cooled by a significantly greater amount which is advantageous for particular types of beers.

Last not least it is also particularly advantageous when a temperature of water flowing from the high temperature water outlet of the hot water storage device into the hot water inlet of the mash container during brewing operations of the brewing plant is in a range of 90° C. to 99° C., advantageously 95° C. or higher, further advantageously 96° C. or higher in the high temperature water outlet.

In an advantageous embodiment of the invention at least one respective high temperature water inlet and at least one high temperature water outlet of the hot water storage device are formed by a common high temperature water connection of the hot water storage device. This high temperature water connection can thus be flowed through in both directions and used as an inlet and as an outlet. In order to be able to operate with different filing levels of the hot water storage device, the high temperature water connection is advantageously fed by tank connections arranged at different levels which can be switched on or off by a cut off device depending on the filling level.

In another advantageous embodiment of the invention, at least one respective low temperature water inlet and at least one low temperature water outlet of the hot water storage device are formed by a common low temperature water connection of the hot water storage device. This low temperature water connection can thus also be flowed through in both directions and used as an inlet and as an outlet.

In another advantageous embodiment heat of the condensate is recovered through an additional condensate heat exchanger. Thus, the heat of the hot condensate is recovered by cold water and hot water with approximately 80° C. is generated.

Another advantageous embodiment of the brewing plant according to the invention including a fresh water energy storage device includes an additional low temperature primary energy source, e.g. a wood chip or wood pellet heater having hot water and temperatures of up to 110° C. Heating plants of this type below 110° C. are not subject to TUV inspection and are used in large numbers in residential applications. Therefore, they are relatively inexpensive compared to high temperature heaters. Thus, the hot water storage device would have to be configured as a pressure vessel. In this pressure vessel head temperatures of 106° C. to 108° C. are provided. This “head energy” could then be used for heating a wort boiling process. Ideally an external boiler is provided for this purpose which is then configured as plate heat exchanger or tube bundle heat exchanger.

An additionally provided external heating plant configured as a primary energy source advantageously includes low return temperatures at an ideal spread between outgoing and return temperature of 10-20 K. Therefore the brewing plant should be operated so that a similar or the same temperature spread is established in the hot water storage device between its high temperature portion and its low temperature portion during operations, e.g., during a production week. Therefore, it is advantageous when other consumers in the brewery are heated by the thermal energy from the hot water storage device in order to obtain a wide temperature spread in the hot water storage device. Other heat sinks in which thermal energy from the hot water storage device can be used are e.g. building heat arrangement bottle washing machines or cleaning equipment.

Also, other heat sources can be used for heating the hot water storage device through secondary heat exchangers, wherein these heat sources may be waste heat from beer cooling or compressed air generation.

Advantageously the brewing plant according to the invention also includes a complete thermal insulation of sud containers, in particular of the wort kettle and the whirlpool. This way a brewing plant is provided that has a comprehensive energy savings and energy recovery concept. Comprehensive thermal insulation of the sud containers and minimum heat losses facilitate heat recovery from the hot wort at a maximum temperature level and thus optimum utilization of the recovered energy. Due to the higher temperature differences a smaller amount of hot water is required for heat recovery which helps to prevent excessive amounts of hot water.

Advantageously the entire hot water loop is connected to a CIP cleaning system so that respective residuals and deposits can be removed. The hot water storage device advantageously includes cleaning devices like e.g. spray nozzles for cleaning the tanks of the hot water storage device.

### BRIEF DESCRIPTION OF THE DRAWINGS

Advantageous embodiments of the invention with additional design features and additional advantages are subsequently described with reference to the appended drawing figures, wherein:

FIG. 1 illustrates a simplified block diagram of a known brewing plant; and

FIG. 2 illustrates a simplified block diagram of a brewing plant according to the invention.

### DETAILED DESCRIPTION OF THE INVENTION

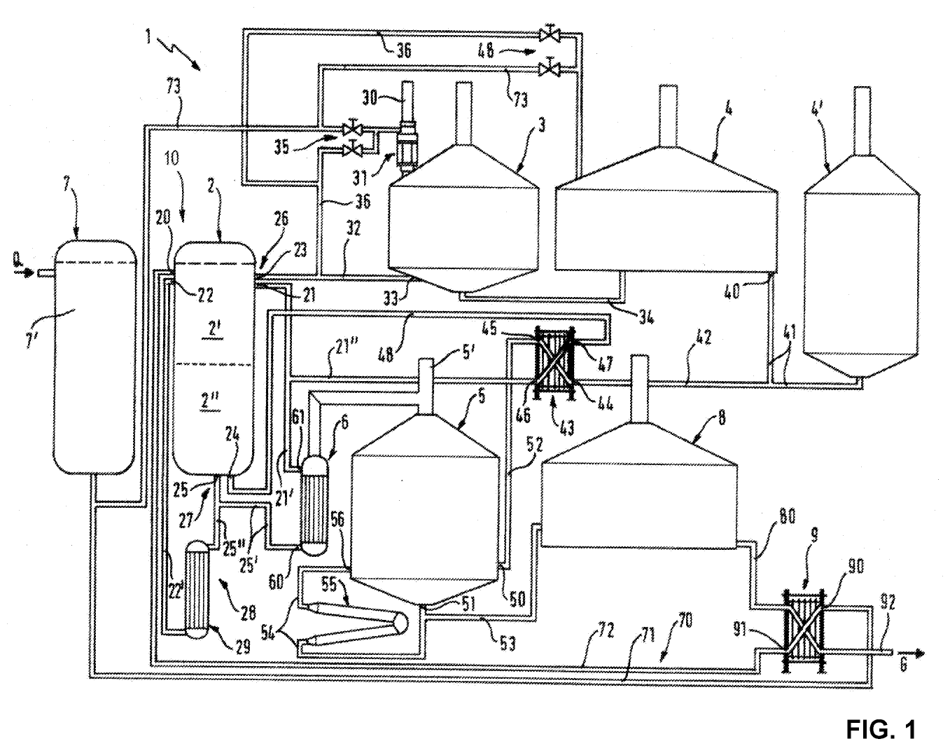

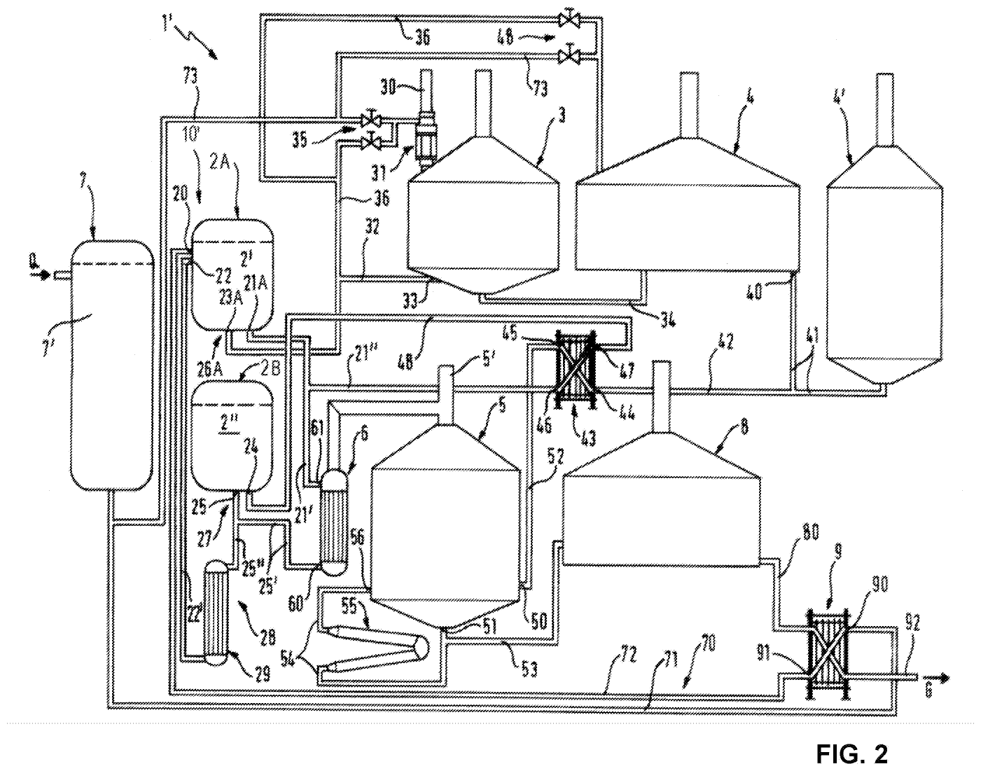

The drawing figures show a simplified block diagram of a brewing plant 1, 1′ including a hot water storage device 10, 10′, only showing essential physical components of the brewing plant 1, 1″ and only fluid connection lines that are required for describing the invention. The brewing plant 1 illustrated in FIG. 1 is a known brewing plant and the brewing plant 1′ shown in FIG. 2 is a brewing plant according to the invention.

The brewing plant 1 of FIG. 1 includes a hot water storage device 10 that is formed by a hot water stratified storage device 2 that forms a thermal energy storage device of the brewing plant 1. Furthermore, FIG. 1 shows a mash container 3, a lauter tun 4, a wort kettle 5 and a whirlpool 8 and a cold-water storage device 7 configured as essential physical components of the brewing plant 1. The cold-water storage device 7 is connected to an external fresh water source Q, as indicated by the arrow Q and forms a buffer storage for a fresh water supply 7′. In order to achieve a minimum hardness of the fresh water a water softening plant is advantageously provided between the fresh water source Q and the cold-water storage device 7.

The hot water stratified storage device 2 is a container, e.g., a tank configured to receive water with different temperature layers. The hot water stratified storage device 2 forms a high temperature portion 2′ in its upper container portion that includes a hotter water layer and a low temperature portion 2′ in its lower container portion that includes a water layer that is less hot.

The stratified hot water storage device 2 includes three temperature water inlets 20, 21, 22 in its upper container portion respectively forming a tank connection through which hot water can be introduced into the upper portion of the stratified hot water storage device 2. Furthermore, the upper container portion of the stratified hot water storage 2 also includes a high temperature water outlet 23 forming a tank connection through which hot water can be drained from the stratified hot water storage device 2. It is appreciated that more or less water inlets or water outlets can be provided. By the same token it is possible to combine at least one water inlet and one water outlet with one another so that hot water can be introduced into the high temperature portion 2′ of the stratified hot water storage device 2 through a combined hot temperature water connection 26, and by the same token water can be withdrawn from the stratified hot water storage device 2 through the combined high temperature water connection 26. In order to consider various filing levels of the stratified hot water storage device 2, the high temperature water connection 23 can be advantageously fed by plural tank connections (water inlet/water outlet) that are arranged at different levels, which can be switched on or off by a respective blocking device depending on the filling level.

At least one low temperature water inlet 24 and at least one low temperature water outlet 25 are provided in the lower container portion of the hot water stratified hot water storage device 2 including the low temperature portion 2″, advantageously at a lower base of the stratified hot water storage device 2, wherein a first low temperature fluid conduit 25′ and a second low temperature fluid conduit 25″ that also form a respective tank connection are connected to the low temperature water outlet 25. Also these connections can be combined respectively in a single low temperature water connection 27 so that the combined low temperature water connection 27 can be used as a water inlet as well as a water outlet. It is also possible to provide more than two layers in the stratified hot water storage device 2, wherein additional water inlets and water outlets are provided for the additional layers.

Fresh water is fed from the cold fresh water storage 7′ of the cold-water storage 7 through a fresh water conduit 70 to the stratified hot water storage device 2, wherein the cold fresh water is initially fed through an outer feed conduit 71 from the cold-water storage device 7 to a wort cooler 9 that is configured as a heat exchanger. Cold fresh water fed through the outer feed conduit 71 enters a cold-water inlet 90 of the wort cooler 9 and is heated in the heat exchanger of the wort cooler 9 by hot wort which is fed from the whirlpool 8 to the wort cooler 9 through a wort drain conduit 80 to be described infra, wherein the temperature of the fresh water at an exit from the wort cooler 9 is in a range of 95° C. to 98° C. or can even reach a temperature of 99° C. This hot fresh water exits the wort cooler 9 through a hot water outlet 91 and is supplied from there through an inner feed conduit 72 to the brewing plant 1 wherein the inner feed conduit 72, like all hot water conduits (high temperature and low temperature conduits) is advantageously thermally insulated throughout, wherein the hot fresh water is fed to the high temperature water inlet 20 of the stratified hot water storage device 2 where it enters the high temperature portion 2′. Thus, heated fresh water is fed to the stratified hot water storage device 2, during brewing operations of the brewing plant 1.

As a matter of principle, it is also possible and common for starting the brewing plant 1 that cold fresh water is initially provided at the beginning of an operating cycle from the fresh water storage 7′ into the stratified hot water storage device 2, and then initially heated in a heating cycle 28. The heating cycle 28 thus includes an external heater 29 that is heated with primary energy, e.g. with gas, heating oil, wood chips or wood pallets. The heating device 29 is connected through a second low temperature fluid conduit 25″ with the low temperature water outlet 25 of the stratified hot water storage device 2, and through a second high temperature fluid conduit 22′ with the high temperature water inlet 22 of the stratified hot water storage device 2. This way water drawn from the lower low temperature portion 2″ of the stratified hot water storage device 2, can be fed by a pump through the external heating device 29 and the high temperature fluid conduit 22′ back into the high temperature portion 2′ of the stratified hot water storage device 2 so that the cold fresh water originally introduced into the stratified hot water storage device 2 is quickly heated to the predetermined operating temperatures.

Cold fresh water from the fresh water storage 7′ is additionally fed through a fresh water conduit 73, directly connected to the cold-water storage 7 or branching off from the outer feed conduit 71 to a first mixing device 25, associated with the mash container 3 and a second mixing device 48, associated with the lauter tun 4. A hot water conduit 36 fed with hot fresh water by the high temperature water outlet 23 as illustrated in FIG. 1, or by the high temperature fluid conduit 21 feeds hot water to the respective mixing device 35, 48. The cold fresh water is mixed in both mixing devices with the hot water from the stratified hot water storage device 2 in order to achieve the desired temperature.

A pre-mash device 31 is connected upstream of the mash container 3, wherein shredded malt and other starch bearers from a storage are provided to the pre-mash device 31 through a feed conduit 30. The cold fresh water is mixed with the hot fresh water in order to achieve the desired temperature in the first mixing device 35 associated with the mash container 3 and the temperature-controlled water is fed to the pre-mash device 31. The starch bearers are mixed in the pre-mash device 31 in a continuous flow process with temperature controlled fresh water (between 35 and 65° C. advantageously over 50° C.) fed from the first mixing device 35 to form a suspension, the so-called mash which is subsequently introduced in the mash container 3.

The mash is fed from the mash container 3 through a mash conduit 34 into the lauter tun 4 where the mash is lautered. For this purpose, the malt extraction is extracted in the lauter tun 4 by hot water, the so called sparging water which is fed into the lauter tun 4 by the second mixing device 48 associated with the lauter tun 4, at a temperature of 78 to 80° C. Thus, lauter wort generated in the lauter tun 4 is drained from the lauter tun 4 by a lauter wort exit 40 and a lauter wort conduit 41 and initially stored in an intermediary manner in a lauter wort container 4′.

Overall, approximately 50% of the fresh brew water is added during initial mashing and the other 50% is added in the lauter tun in order to wash the remaining extract out of the draff cake after draining the first wort. In order to save energy also in this step the last flushing can be performed with cold water. The cold water displaces the last extract from the draff cake and uses the stored heat in the draff so that the cold water does not have to be heated by other thermal energy sources but extracts the heat from the draff cake and is thus heated up.

The lauter wort is fed from the lauter wort container 4′ or directly from the lauter tun 4 through the first lauter wort conduit 41 and fed to a lauter wort heater 43 through a second lauter wort conduit 42 flow connected with the first lauter wort conduit 41, wherein the lauter wort heater 43 is also configured as a heat exchanger. The fed lauter wort enters through a low temperature wort inlet 44, into this heat exchanger, is heated therein and exits again from a high temperature wort outlet 45 which the heated lauter wort is run through a third lauter wort conduit 52 to a lauter wort inlet 50 of the wort kettle 5 so that the lauter wort enters the wort kettle 5 through the lauter wort inlet 50. Alternatively, the lauter wort can also be collected in the whirlpool 8 when there is a low sud sequence and from there the lauter wort can be heated by a lauter wort heater 43 during transfer into the wort kettle 5.

The wort kettle 5 is typically connected with the lauter wort inlet 50, a wort outlet 51 and a wort vapor chimney 5′ wherein wort vapor generated by wort boiling exits from the wort vapor chimney 5′. An exhaust vapor condenser 6 configured as a heat exchanger is typically associated with the wort kettle 5 and flow connected with the wort vapor chimney 5′, so that exhaust vapor flows into the exhaust vapor condenser where it can condense as will be described infra. An external wort boiler 43 is associated with the wort kettle 3 in order to boil the wort as will be described infra.

A wort circulation conduit 54 runs from the wort outlet 51 of the wort kettle 5 through the external wort boiler 55 operated with primary energy to a hot wort inlet 56 of the wort kettle. Preheated wort included in the wort kettle and initially introduced through the lauter word conduit 52 into the wort kettle 5 is circulated by a circulation pump through the wort circulation conduit 54 and the external wort boiler 55 and further heated by the external wort boiler 55 to a boiling temperature. Instead of this external circulation heating certainly also any other known type of wort heating, e.g. by an inner boiler or by heat exchangers that are arranged in the wort pan 5 can be provided.

Finished wort exiting from the wort outlet 51 is conducted into the whirlpool 8 by a wort transfer conduit 53 branching off from the wort recirculation conduit 53 where a solid liquid separation is performed in a known manner. The separated liquid phase of the wort the so-called finished wort is drained from the whirlpool 8 through the wort drain conduit 80 and introduced into the wort cooler 9 as described supra. The cooled down finished wort exiting from the wort cooler 9 is then run out of the brewing plant 1 through a fermentation conduit 92 and introduced into a fermentation tank G which is indicated by the arrow G.

The brewing plant 1 as well as the brewing plant 1′ according to the invention is flowed through by brew liquid in the fresh water loop from the source Q to the fermentation tank G, wherein the brew liquid changes from fresh water to mash to lauter wort, wort and eventually finished wort which is conducted through the fermentation conduit into the fermentation tank G.

In a brewing plant 1, as well as in the brewing plant 1′ according to the invention, the temperature management, in particular heat recover is performed by the brew liquid as will be described infra.

The first low temperature fluid conduit 25′ runs from the low temperature water outlet 25 of the stratified hot water storage device 2 to a low temperature water connection 60 of the exhaust vapor condenser 6 associated with the wort kettle 5. Exhaust vapor rising from the wort kettle 5 is cooled in the exhaust vapor condenser 6 by water fed through the low temperature fluid conduit 25′, wherein the water has a temperature of e.g. 80° C. and condensed, wherein the recovered exhaust vapor condensate is discarded. The heat from the hot exhaust vapor condensate can be recovered by a condensate cooler in order to heat e.g. fresh water. Low temperature water fed by the low temperature fluid conduit 25 is heated during the condensation process in the exhaust vapor condenser 6 e.g. to a temperature between 95° C. and 99° C. This heated water is fed through a first high temperature fluid conduit 21′ to the high temperature water inlet 21 of the stratified hot water storage device 2 and conducted from there into the high temperature portion 2′.

The high temperature portion 2′ of the stratified hot water storage device 2 is flow connected from a high temperature water outlet 23 through a mash water conduit 32 with the mash container 3. There the mash water conduit 32 leads into a hot water inlet 33 at a lower base of the mash container 3 so that hot water fed by a pump from the high temperature portion 2′ of the stratified hot water storage device 2 that has a temperature in a range of 90° C. to 99° C. and advantageously above 95° C. enters the mash included in the mash container 3 from below. Thus, a stirring device arranged in the mash container generates turbulence in the mash that has a starting temperature significantly below the temperature of the introduced hot water so that the turbulence causes a quick mixing of the introduced hot water with the mash so that a mixing temperature that is evenly distributed in the mash is quickly established wherein the mixing temperature is between the original mash temperature and the temperature of the introduced hot water. This way the mash can be quickly raised to a pre-determined temperature level which has to be maintained for a predetermined mash resting period. Since beer brewing typically includes plural so called mash resting periods in sequence with respectively higher temperature, the mashing process and thus the entire brewing process are accelerated since a predetermined resting temperature can be quickly achieved by introducing hot fresh water from the stratified high temperature storage device 2 into the mash container 3. The temperature adjustment caused by introducing hot fresh water into the mash is significantly faster than conventional heating of the mash container 3 with an internal or external heater through heat exchangers that provide significantly slower heat transfer into the mash.

The fresh water heated in the exhaust vapor condenser 6 is also used as a heating medium in the lauter wort heater 43, in that the fresh water is branched off by a high temperature branch conduit 21, branching off from the first high temperature fluid conduit 21′ and being conducted to a high temperature fluid connection 46 of the lauter wort heater 43 as a partial flow. The fresh water exiting from the lauter wort heater 43 through a low temperature fluid outlet 47, and that is cooled down to a temperature of approximately 80° C. is run through a low temperature return conduit 48 to the low temperature water inlet 24 of the stratified hot water storage device 2 and flows into the low temperature portion 2′ of the stratified hot water storage device 2.

FIG. 2 illustrates a brewing plant 1′ according to the invention that is improved over the brewing plant of FIG. 1, wherein the hot water storage device 10′ is formed by an arrangement of two or more separate hot water storage containers 2A and 2B, e.g. tanks. Identical or like reference numerals in FIG. 2 designate identical or like components of the brewing plant of FIG. 1, so that merely differences between the two brewing plants 1 and 1′ are described infra in order to avoid unnecessary repetition. Otherwise, the same descriptive statements apply for the brewing plant 1′ that are provided with reference to the brewing plant 1 of FIG. 1.

A first upper hot water storage container 2A (high temperature storage container) forms the high temperature portion 2′ in its interior and a second lower hot water storage container 2B in FIG. 2 (low temperature hot water storage container) forms the low temperature portion 2″ in its interior. The first hot water storage container 2A thus includes a hotter water volume than the second hot water storage container 2B which includes a less hot water volume.

The first hot water storage container 2A advantageously includes two high temperature water inlets 20, 22 in its upper container portion wherein the high temperature water inlets respectively form a tank connection through which hot water can be introduced into the first hot water storage container 2A, advantageously into its upper portion. Furthermore, two additional tank connections 21A, 23A are provided in the lower container portion wherein hot water can be drained from the first hot water storage container 2A or introduced into the first hot water storage container 2A. The lower hot water inlet 21A can also be alternatively provided in the upper container portion like the high temperature water inlet 21 in the embodiment of FIG. 1.

Also, in the embodiment according to FIG. 2 it is possible to provide more or fewer water inlets or water outlets at the first hot water storage container 2A. By the same token it is possible to combine at least one water inlet and a water outlet with one another so that hot water can be introduced into the high temperature portion 2′ and water can be drawn from the high temperature portion 2′ through a combined high temperature water connection 26A. The high temperature water inlets 20, 22 forming the tank connections of the first hot water storage container 2A correspond to the high temperature water inlets 20, 22 of the stratified high temperature hot water storage device 2 according to the first embodiment and the high temperature water inlets 20, 22 are connected in the same way to the tubing of the brewing plant as illustrated in the embodiment of FIG. 1. The same applies for the lower tank connections of the first hot water storage container 2A, namely the high temperature water outlet 23A and the high temperature water inlet 21A which correspond to the high temperature water outlet 23 or the high temperature water inlet 21 of the stratified high temperature hot water storage device 2 in FIG. 1.

The second hot water storage container 2B including the low temperature portion 2′ advantageously includes the at least one low temperature water inlet 24, and the at least one low temperature water outlet 25, at a lower base of the storage container 2B, wherein the first low temperature fluid conduit 25′ and the second low temperature fluid conduit 25″ are connected to the at least one low temperature water outlet 25, respectively forming a tank connection. Also, these conduits can be respectively combined in the combined low temperature water connection 27 so that the low temperature water connection 27 can serve as a water inlet as well as a water outlet. The at least one low temperature water inlet 24 can also be alternatively provided in the upper portion of the second hot water storage container 2B.

The at least one low temperature water inlet 24 forming a tank connection of the second hot water storage container 2B corresponds to the at least one low temperature water inlet 24 of the stratified high temperature hot water storage device 2 of the first embodiment. By the same token, the at least one low temperature water outlet 25 of the second hot water storage container 2B corresponds to the low temperature water outlet 25 of the stratified high temperature hot water storage device 2 of the first embodiment according to FIG. 1. The at least one low temperature water inlet 24, and the at least one low temperature water outlet 25 of the second hot water storage container 2B are thus connected in the same manner to the tubing of the brewing plant as illustrated in FIG. 1.

The function of the hot water storage device 10′ according to the second embodiment analogously corresponds to the function of the hot water storage device 10 according to the first embodiment wherein the first hot water storage container 2A with the high temperature portion 2′ corresponds to the upper portion of the stratified hot water storage device 2 with the high temperature portion 2′ and wherein the second hot water storage container 2B with the low temperature portion 2′ corresponds to the lower portion of the stratified high temperature hot water storage device 2 with the low temperature portion 2′.

Also other heat generators and heat consumers can be connected to the brew liquid flow formed by the initially provided fresh water e.g., directly or through heat exchangers. The brewing plant 1, 1′ according to the invention simultaneously uses the brew liquid as a heat transfer medium so that no separate fluid cycle is required for recovering thermal energy which is different from the prior art.

Reference numerals in the description and the drawings improve enablement to practice the invention but do not limit the spirit and scope of the invention which is exclusively defined by the appended patent claims.

### REFERENCE NUMERALS AND DESIGNATIONS

1 brewing plant
1′ brewing plant
2 stratified hot water storage device
2A first hot water storage container
2B second hot water storage container
2′ high temperature portion
2″ low temperature portion
3 mash container
4 lauter tun
4′ lauter wort container
5 wort kettle
5′ wort vapor chimney
6 exhaust vapor condenser
7 cold water storage
7′ fresh water supply
8 whirl pool
9 wort cooler
10 hot water storage device
10′ hot water storage device
20 high temperature water inlet
21 high temperature water inlet
21′ high temperature fluid conduit
21″ high temperature branch conduit
21A high temperature water inlet
22 high temperature water inlet
22 high temperature fluid conduit
23 high temperature water outlet
23A high temperature water outlet
24 low temperature water inlet
25 low temperature water outlet
25′ low temperature fluid conduit
25″ low temperature fluid conduit
26 high temperature water connection
26A high temperature water connection
27 low temperature water connection
28 heating loop
29 heating device
32 mash water conduit
33 hot water inlet
34 mash conduit
35 first mixing device
36 hot water conduit
40 lauter wort exhaust
41 first lauter wort conduit
42 second lauter wort conduit
43 lauter wort heater
44 low temperature wort inlet
45 high temperature wort outlet
46 high temperature fluid connection
47 low temperature fluid outlet
48 second mixing device
50 lauter wort inlet
51 wort outlet
52 third lauter wort conduit
53 wort transfer conduit
60 low temperature water connection
61 high temperature water connection
70 fresh water feed conduit
71 external feed conduit
72 inner feed conduit
73 fresh water conduit
80 wort drain conduit
90 cold water inlet
91 hot water outlet
92 fermentation conduit
G fermentation tank
Q fresh water source

What is claimed is:

1. A brewing plant, comprising:
a hot water storage device, including a high temperature portion and a low temperature portion, at least one high temperature water inlet, at least one high temperature water outlet, at least one low temperature water inlet, at least one low temperature water outlet;
a mash container;
a lauter tun or a mash filter flow connected with the mash container by a mash conduit;
a wort kettle including a lauter wort inlet, a wort outlet, and an exhaust vapor condenser including a low temperature water connection and a high temperature water connection,
wherein the lauter wort inlet is directly or indirectly connected through a lauter wort conduit with the lauter tun or the mash filter,
wherein the at least one low temperature water outlet of the hot water storage device is connected with the low temperature water connection of the exhaust vapor condenser and the at least one high temperature water inlet of the hot water storage device is flow connected with the high temperature water connection of the exhaust vapor condenser,
wherein the hot water storage device includes at least one first hot water storage container which includes or forms the high temperature portion and at least one second hot water storage container that includes or forms the low temperature portion, and
wherein the hot water storage device configured as an arrangement of two or more hot water storage containers is flow connected through a fresh water conduit with a fresh water storage, and wherein the at least one high temperature water outlet of the hot water storage device is flow connected through a mash water conduit with a hot water inlet of the mash container.

2. A brewing plant comprising:
a hot water storage device, including a high temperature portion and a low temperature portion, at least one high temperature water inlet, at least one high temperature water outlet, at least one low temperature water inlet, at least one low temperature water outlet;
a mash container;
a lauter tun or a mash filter flow connected with the mash container by a mash conduit;
a wort kettle including a lauter wort inlet, a wort outlet, and an exhaust vapor condenser including a low temperature water connection and a high temperature water connection,
wherein the lauter wort inlet is directly or indirectly connected through a lauter wort conduit with the lauter tun or the mash filter,
wherein the wort outlet is flow is directly or indirectly flow connected with a wort cooler,
wherein a cold water inlet of the wort cooler is provided with cold water by an external feed conduit, wherein the cold water is heated in the wort cooler,
wherein the wort cooler includes a hot water outlet to exhaust the hot water, wherein the hot water outlet is flow connected through an internal feed conduit with the at least one high temperature water inlet of the hot water storage device,
wherein the hot water storage device includes at least one first hot water storage container which includes or forms the high temperature portion and at least one second hot water storage container that includes or forms the low temperature portion, and
wherein the external feed conduit is flow connected with the fresh water storage and the external feed conduit and the internal feed conduit form a fresh water feed of the hot water storage device formed by at least two hot water storage containers.

3. A brewing plant, comprising:
a hot water storage device, including a high temperature portion and a low temperature portion, at least one high temperature water inlet, at least one high temperature water outlet, at least one low temperature water inlet, and at least one low temperature water outlet;
a mash container;
a lauter tun or a mash filter flow connected with the mash container by a mash conduit;
a wort kettle including a lauter wort inlet, a wort outlet, and an exhaust vapor condenser including a low temperature water connection and a high temperature water connection,
wherein the lauter wort inlet is directly or indirectly connected through a lauter wort conduit with the lauter tun or the mash filter,
wherein the at least one low temperature water outlet of the hot water storage device is connected with the low temperature water connection of the exhaust vapor condenser and the at least one high temperature water inlet of the hot water storage device is flow connected with the high temperature water connection of the exhaust vapor condenser,
wherein the wort outlet is directly or indirectly flow connected with a wort cooler,
wherein a cold-water inlet of the wort cooler is provided with cold water by an external feed conduit, wherein the cold water is heated in the wort cooler,
wherein the wort cooler includes a hot water outlet to exhaust the hot water, wherein the hot water outlet is flow connected through an internal feed conduit with the high temperature water inlet of the hot water storage device to exhaust the hot water from the wort cooler,
wherein the hot water storage device includes at least one first hot water storage container which includes or forms the high temperature portion and at least one second hot water storage container that includes or forms the low temperature portion, and
wherein the hot water storage device configured as an arrangement of at least two hot water storage containers is flow connected through a fresh water conduit with a fresh water storage and wherein the high temperature water outlet of the hot water storage device is flow connected through a mash water conduit with a hot water inlet of the mash container.

4. The brewing plant according to claim 1, wherein a temperature of water exiting from the high temperature water connection of the exhaust vapor condenser is in a range of 95° C. to 99° C., or between 96° C. and 99° C., or between 98° C. and 99° C. during operations of the brewing plant.

5. The brewing plant according to claim 2, wherein a temperature of water exiting from the wort cooler into the inner feed conduit is in a range of 95° C. to 97° C., or between 96° C. and 97° C. during brewing operations of the brewing plant.

6. The brewing plant according to claim 2, wherein a temperature of water exiting from the wort cooler into the inner feed conduit is at the most by 2° C. less, or at the most by 1° C. less than a temperature of hot wort entering the wort cooler during brewing operations of the brewing plant.

7. The brewing plant according to claim 2, wherein a temperature of water flowing from the fresh water storage through the outer feed conduit into the wort cooler is warmer than 0° C. and colder than 10° C., or 6° C. or colder, or 4° C. or colder.

8. The brewing plant according to claim 1, wherein a temperature of water flowing from the at least one high temperature water outlet of the hot water storage device into the hot water inlet of the mash container during brewing operations of the brewing plant is in a range of 90° C. to 99° C. or 95° C. or higher, or 96° C. or higher.

9. The brewing plant according to claim 1, wherein at least one respective high temperature water inlet and at least one high temperature water outlet of the hot water storage device is formed by a common high temperature water connection of the hot water storage device.

10. The brewing plant according to claim 1, wherein at least one respective low temperature water inlet and at least one respective low temperature water outlet of the hot water storage device is formed by a common low temperature water connection of the hot water storage device.
